(19) United States
(12) Patent Application Publication
(10) Pub. No.: US 2011/0169384 A1
(43) Pub. Date: Jul. 14, 2011

(54) FOOD SHIELD

(75) Inventors: Andrew Padden, Denver, CO (US); Wayne Sirmons, Denver, CO (US); Dennis Bridges, Denver, CO (US)

(73) Assignee: Brass Smith, LLC (Subsidiary of Kevry Corp.), Denver, CO (US)

(21) Appl. No.: 12/687,039

(22) Filed: Jan. 13, 2010

(51) Int. Cl. A47F 10/06; F16M 13/00

(52) U.S. Cl. 312/140.4; 248/226.11

(57) ABSTRACT

A food shield includes a panel mounting mechanism that enables extensive adjustability of the food shield. When the mounting mechanism is clamped to a post, a panel coupled to the mounting mechanism can be adjusted angularly about an axis transverse to a longitudinal axis of the post, and the panel can also be translated in a direction transverse to the axis of rotation. The mounting mechanism may include a clamp that includes a main portion and a swing portion that can swing away from the main portion to enable the clamp to be coupled to a post from a side of the post. Detent mechanisms may be provided for the angular adjustment and the translational adjustment. The mounting mechanism may also include a locking mechanism that when engaged fixes the panel in a certain angular position.

### BACKGROUND OF THE INVENTION

Food shields, also sometimes called sneeze guards, are used in a variety of settings. Typically, a clear panel is suspended over a buffet, smorgasbord, salad bar, retail display, or other kind of food display to protect the food from falling debris or other contamination. One or more panels may also be placed between the displayed food and customers, such that the customers must reach under the food shield to have access to the food, and the opportunities for contamination are limited.

Various health and safety codes may specify the required position of the food shield in relation to the food display. Because food shields are used in many different locations, it is desirable that a food shield be easily adjustable, so that it can be adapted to different spaces and uses. Some prior food shields are described in U.S. Pat. No. 6,588,836 to Yatchak et al., issued Jul. 8, 2003 and titled “Sneeze Guards and Methods for Their Construction”, the entire disclosure of which is hereby incorporated herein by reference for all purposes. While the sneeze guards described in that patent have proven very useful, even more adjustability and configurability are desirable.

### BRIEF SUMMARY OF THE INVENTION

Embodiments of the invention provide a food shield with extensive adjustability and configurability. Panels may be mounted to posts using mounting mechanisms. A mounting mechanism may be positioned at an arbitrary location along the length of a post, and provides multiple adjustments for a panel coupled to the mounting mechanism. The panel may be rotated about an axis transverse to a longitudinal axis of the post, and the panel may also be translated in a direction transverse to the rotational axis. The mounting mechanisms may be configured such that two substantially identical mounting mechanisms, one inverted with respect to the other, can mount two panels to the same post with their rotational axes being aligned. No special mounts may be required for different ends of a panel or for coupling two panels to the same post. The mounting mechanisms may include a clamp that can swing open to enable the clamp to be engaged with a post from a side of the post, so that cutting or disassembly of posts may be avoided when reconfiguring a food shield.

In some embodiments, a food shield comprises at least one post having a longitudinal axis defining a length and a clamp coupled to the post. The clamp is loosenable to enable the clamp to be moved along the length of the post, and the clamp is also tightenable to fix the clamp at a certain location on the post. The food shield also includes a swivel coupled to the clamp. The swivel is rotatable with respect to the clamp about a rotational axis that is transverse to the longitudinal axis of the post. The food shield also comprises an arm coupled to the swivel and extending from the swivel. The arm is translatable with respect to the swivel along a translational axis that is transverse to the rotational axis. And finally in these embodiments, the food shield comprises a panel coupled to the arm such that the panel is movable to different angular positions by rotating the arm, and the panel is movable to different translational locations by translating the arm with respect to the swivel. The clamp may further comprise a main portion and a swing portion that is rotatable away from the main portion to open the clamp, enabling the clamp to be coupled to the post from a side of the post. The clamp may further comprise a tightening mechanism operable to tighten the main portion and the swing portion of the clamp to the post, to fix the clamp at a certain location on the post, the tightening mechanism also being loosenable to enable the clamp to be moved along the length of the post. The tightening mechanism may comprise a screw or bolt passing through either the main portion or the swing portion and threaded into the other portion.

The food shield may further comprise a detent mechanism coupled to the clamp and the swivel, the detent mechanism defining a set of angular detent positions for the panel, and a locking mechanism that when engaged fixes the panel in a certain angular position. When the locking mechanism is disengaged, the panel may be movable angularly without the use of tools.

The arm may comprise two holes, one near each end of the arm, through which threaded fasteners pass to couple the panel to the arm. In these embodiments, the food shield further comprises two caps, each cap having a shank and an enlarged head, and the panel resides between the heads and the arm and is drawn toward the arm by the threaded fasteners. Each cap shank may include a flattened portion, and the food shield may further comprise a plate cover between the panel and the arm, the plate cover comprising two flat-sided holes, one aligned with each hole in the arm. In these embodiments, the flattened portions of the shanks engage the flat-sided holes to prevent rotation of the caps by the threaded fasteners.

The food shield may further comprise a bushing in the clamp, the bushing being made of a material that substantially prevents marring of the post by the clamp. The food shield may further comprise a set of detent holes in the arm, and a latch coupled to the swivel, the latch comprising a protrusion configured to engage one of the detent holes at a time to hold the arm in a certain translational location. In these embodiments, the latch is actuatable to disengage the protrusion to enable the arm to move to another translational position. The latch may be actuatable without the use of tools.

The post may be vertical. The post may be horizontal. In some embodiments, the food shield further comprises a second post displaced from the first, a second clamp coupled to the second post, a second swivel coupled to the second clamp, and a second arm coupled to the second swivel, with the panel also being coupled to the second arm. In some embodiments, the food shield further comprises a second clamp coupled to the post, a second swivel coupled to the second clamp, a second arm coupled to the second swivel; and a second panel coupled to the second arm.

In some embodiments, a food shield, comprises at least one post having a longitudinal axis defining a length, and a clamp coupled to the post, the clamp comprising a main portion and a swing portion that is rotatable away from the main portion to open the clamp, enabling the clamp to be coupled to the post from a side of the post. The food shield further comprises a tightening mechanism operable to tighten the main portion and the swing portion of the clamp to the post, to fix the clamp at a certain location on the post, and the tightening mechanism is also loosenable to enable the clamp to be moved along the length of the post. The food shield further comprises an arm coupled to the clamp, the arm being rotatable with respect to the clamp about a rotational axis that is transverse to the longitudinal axis, and a panel coupled to the arm such that the panel is movable to different angular positions by rotating the arm.

In some embodiments, a food shield comprises at least one post having a longitudinal axis defining a length, and a clamp coupled to the post, the clamp being loosenable to enable the clamp to be moved along the length of the post, and the clamp also being tightenable to fix the clamp at a certain location on the post. The food shield according to these embodiments further comprises a swivel coupled to the clamp, and the swivel is rotatable with respect to the clamp about a rotational axis that is transverse to the longitudinal axis of the post. The food shield further comprises an arm coupled to the swivel and extending from the swivel, and a panel coupled to the arm such that the panel is movable to different angular positions by rotating the arm, and the panel is movable to different translational locations by translating the arm with respect to the swivel. The food shield according to these embodiments further comprises a detent mechanism coupled to the clamp and the swivel, the detent mechanism defining a set of angular detent positions for the panel, and a locking mechanism that when engaged fixes the panel in a certain angular position. When the locking mechanism is disengaged, the panel may be movable angularly without the use of tools.

In some embodiments, a food shield comprises a post having a longitudinal axis defining a length and a first clamp and a second clamp coupled to the post, each clamp comprising a tightening mechanism operable to tighten the clamp to the post to fix the clamp at a certain location on the post, the tightening mechanism also being loosenable to enable the clamp to be moved along the length of the post. The food shield according to these embodiments further comprises a first arm coupled to the first clamp, the first arm being rotatable with respect to the first clamp about a first rotational axis that is transverse to the longitudinal axis, and a second arm coupled to the second clamp, the second arm being rotatable with respect to the second clamp about a second rotational axis that is transverse to the longitudinal axis. The food shield further comprises first and second panels coupled respectively to the first and second arms such that each panel is independently movable to different angular positions by rotating its respective arm. The first and second clamps are substantially identical, one clamp inverted with respect to the other to align the first and second rotational axes. The two rotational axes may be coplanar and intersecting. The two rotational axes may be collinear.

In other embodiments, a method of protecting displayed food items comprises providing a food shield comprising at least one post having a longitudinal axis defining a length, and a clamp coupled to the post, the clamp being loosenable to enable the clamp to be moved along the length of the post, and the clamp also being tightenable to fix the clamp at a certain location on the post. A swivel is also provided coupled to the clamp, the swivel being rotatable with respect to the clamp about a rotational axis that is transverse to the longitudinal axis of the post. An arm is provided coupled to the swivel and extending from the swivel, the arm being translatable with respect to the swivel along a translational axis that is transverse to the rotational axis. A panel is also provided coupled to the arm such that the panel is movable to different angular positions by rotating the arm, and the panel is movable to different translational locations by translating the arm with respect to the swivel. The method further comprises rotating and translating the arm to position the panel in a combination of a certain angular position and a certain translational location such that the panel is between the displayed food items and a viewing location. In some embodiments, the method further comprises engaging a locking mechanism to hold the panel in the certain angular position.

In some embodiments, a panel mounting assembly for mounting a panel in a food shield comprises clamp comprising a main portion and a swing portion that is rotatable away from the main portion to open the clamp, enabling the clamp to be coupled to the post from a side of a post, the clamp also comprising a tightening mechanism for tightening the clamp to the post to fix the clamp at a certain longitudinal position on the post. In these embodiments, the mounting assembly further comprises a swivel rotatably coupled to the clamp main portion and configured to rotate about an axis that is transverse to a longitudinal axis of the post, and an arm coupled to the swivel, the arm configured to translate along an axis that is transverse to the axis of rotation, the arm comprising features, for coupling a panel to the arm. In some embodiments, the panel mounting assembly further comprises a detent mechanism coupled to the clamp and the swivel, the detent mechanism defining a set of angular detent positions for the swivel, and a locking mechanism that when engaged fixes the swivel in a certain angular position in relation to the clamp main portion. When the locking mechanism is disengaged, the swivel may be rotatable about the axis of rotation without the use of tools. In some embodiments, the locking mechanism is a screw, and the panel mounting assembly further comprises a moveable cover for covering the screw. In some embodiments, the detent mechanism comprises a detent disk fixed to the clamp main portion, the detent disk having a set of holes near its perimeter, and at least one ball plunger fixed to the swivel and engaging the detent disk such that when a ball of the ball plunger encounters one of the holes, a detent position is defined. In some embodiments, the panel mounting assembly further comprises a set of detent holes in the arm and a latch coupled to the swivel, the latch comprising a protrusion configured to engage one of the detent holes at a time to hold the arm in a certain translational location, and the latch is actuatable to disengage the protrusion to enable the arm to move to another translational position. In some embodiments, the arm comprises two holes near its ends, and the mounting assembly further comprises a plate cover having two flat-sided holes through it, each flat-sided hole aligned with one of the holes in the arm. The panel mounting assembly may further comprise at least one bushing in the clamp, the bushing made of a material that substantially prevents marring of the post by the clamp. The tightening mechanism may comprise a screw or bolt, and the panel mounting assembly may further comprise a clip that removably clips to the clamp to hide a head of the screw or bolt.

### BRIEF DESCRIPTION OF THE DRAWINGS

FIG. 1 shows a food shield in accordance with embodiments of the invention.

FIGS. 2A and 2B show enlarged oblique views of mounting assemblies and their attachments to panels, in accordance with embodiments of the invention.

FIGS. 3A and 3B illustrate translational motion of an arm with respect to a swivel of a mounting assembly, in accordance with embodiments of the invention.

FIG. 4 shows assembled and exploded oblique views of a mounting assembly, and shows details of the operation of the mounting assembly, in accordance with embodiments of the invention.

FIGS. 5A-5D show oblique, top, side, and bottom views respectively of an example arm.

FIG. 6 shows a portion of a food shield in accordance with embodiments of the invention.

FIG. 7 shows a food shield having two panels positioned parallel with the longitudinal axis of a post and at right angles to each other, in accordance with embodiments of the invention.

FIG. 8 illustrates another arrangement for a food shield, in accordance with embodiments of the invention.

FIG. 9 illustrates another example arrangement for a food shield in which several panels are positioned as shelves, in accordance with embodiments of the invention.

FIG. 10 illustrates another example arrangement for a food shield in which a panel is suspended from an overhead surface, in accordance with embodiments of the invention.

FIG. 11 illustrates another example arrangement for a food shield in which a post is mounted to a vertical surface, in accordance with embodiments of the invention.

FIG. 12 illustrates a food shield having one horizontal and one vertical panel, in accordance with embodiments of the invention.

FIG. 13 illustrates a food shield having two vertical panels, in accordance with embodiments of the invention.

FIG. 14 illustrates a food shield having a non-planar panel, in accordance with embodiments of the invention.

### DETAILED DESCRIPTION OF THE INVENTION

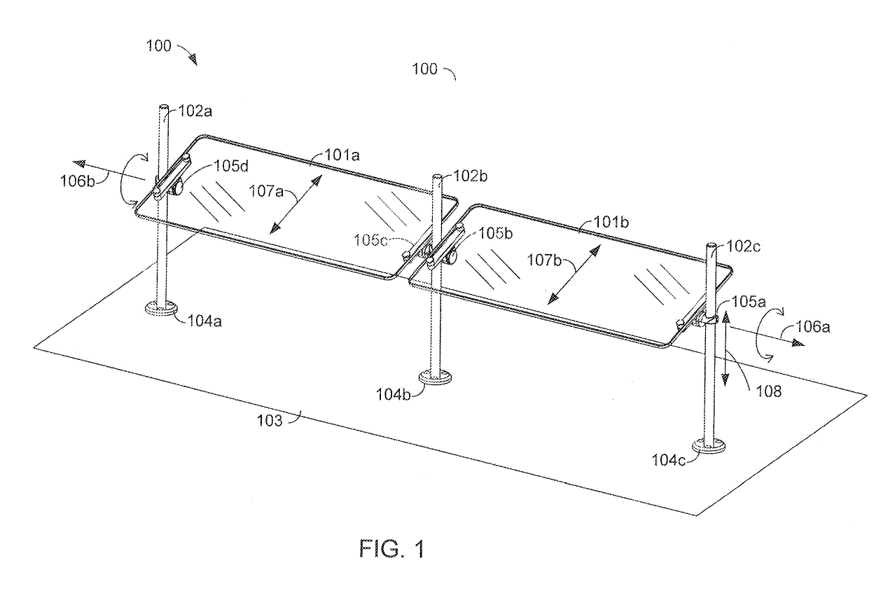

FIG. 1 shows a food shield 100 in accordance with embodiments of the invention. Food shield 100 comprises two panels 101a and 101b, suspended from posts 102a, 102b, and 102c. Panels 101a and 101b may be, for example, made from sheets of clear material to so that food displayed on base 103 can be viewed through the panels. Suitable materials for panels 101a and 102b may include glass, acrylic, or polycarbonate, or other transparent materials. In some applications, the panels need not be transparent, and may be made of any suitable material.

Posts 102a-102c are typically round metal tubes of sufficient strength to hold panels 101a and 101b, although other shapes and materials are possible. For example, posts 102a-102c may be made of steel, aluminum, brass, or another metal. Non-metallic posts are also possible. Posts 102a-102c may be plated or coated, for example for decorative purposes or for additional durability. Other decorative finishes may also be applied. The posts may be attached to base 103 by any suitably secure method, for example by bolts through mounting feet 104a-104c.

Four identical mounting assemblies 105a-105d couple the panels to the posts. The mounting assemblies define axes 106a and 106b, about which panels 101a and 101b are independently rotatable. In addition, panels 101a and 101b are independently translatable transverse to the rotational axes 106a and 106b, as indicated by arrows 107a and 107b, and the panels are independently adjustable along the length of the posts, as indicated by arrow 108.

These degrees of adjustability provide extensive adaptability to different situations in which a food shield may be used. More or fewer panels may be used than are shown in FIG. 1. Multiple panels may be coupled between two posts. A panel may be positioned horizontally to act as a shelf, positioned vertically to act as a divider, or positioned at an angle as shown in FIG. 1. The posts may be simple vertical posts mounted on a base as is shown in FIG. 1, but may also include angles, may be mounted on a vertical surface such as a wall, or may be hung from a ceiling.

Mounting assemblies 105a-105d provide much of the adjustability and adaptability of the system. Each mounting assembly may include a detent mechanism to hold a panel in a preferred angular position, but allow the angular position to be changed by simply rotating the panel. Each mounting assembly may also include a locking mechanism for locking the assembly and associated panel in a certain angular position. When the locking mechanism is disengaged, the panel may be moved without the use of tools by applying enough torque to the mechanism to overcome the detent mechanism. Detents may be provided at, for example, 22.5 degree increments, but other equally-spaced or unequally-spaced increments may be provided.

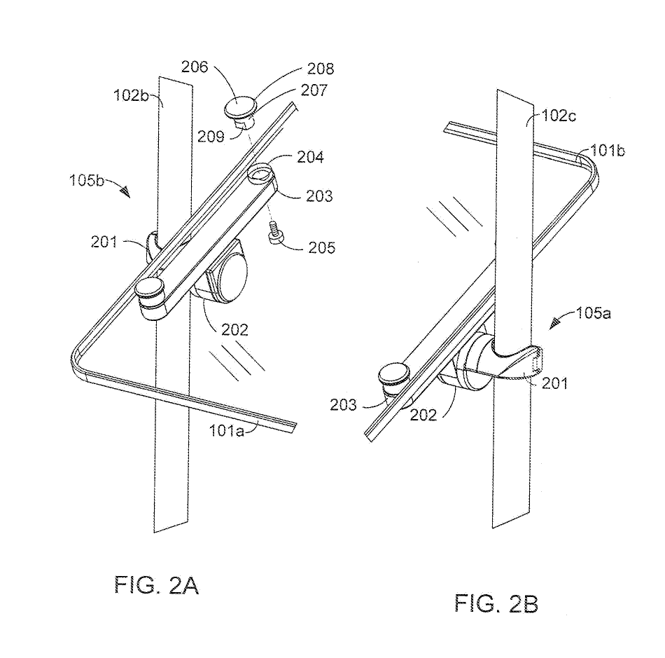

FIGS. 2A and 2B show enlarged oblique views of mounting assemblies 105b and 105a respectively, and their attachments to panels 101a and 101b, in accordance with embodiments of the invention. Assemblies 105a and 105b arc identically constructed. Each of the mounting assemblies includes a clamp 201, a swivel 202 coupled to the clamp 201, and an arm 203 coupled to the swivel 202. Each clamp 201 couples its mounting assembly to its respective post, such as post 102b or post 102c. Each clamp is loosenable to enable the clamp to be moved along the length of its respective post, and the is also tightenable to fix the clamp at a certain location on the post. Because each swivel can rotate to any required angular position, a single kind of mounting assembly can be used for either end of a panel, and there is no need to produce separate “right” and “left” assemblies.

Coupling of the panels to the arms may be accomplished through holes, such as hole 204, through the panels. The holes in the panels align with holes near the ends of the arms, through which fasteners such as screw or bolt 205 pass. At each hole, a cap 206 draws the panel toward the arm when the screw 205 is turned. Cap 206 has a shank 207 and an enlarged head 208 that captures the panel. The shank 207 may have a flattened portion 209 to prevent rotation of cap 206, as will be explained in more detail later.

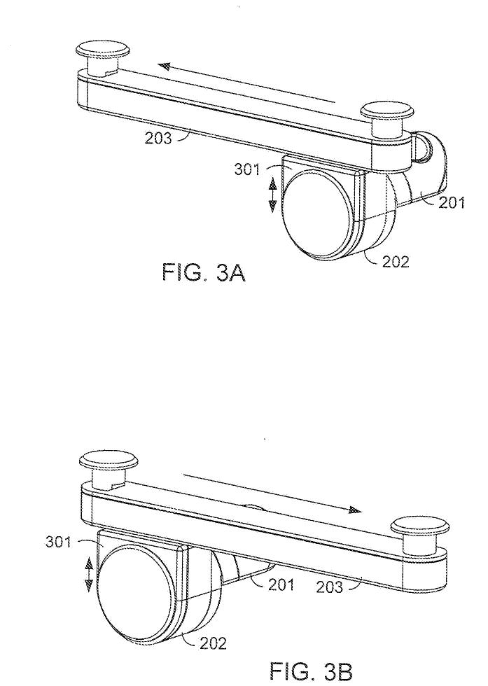

FIGS. 3A and 3B illustrate translational motion of arm 203 with respect to the swivel 202 of one of the mounting assemblies, in accordance with embodiments of the invention. This translational motion allows translational adjustment of the panels. In FIG. 3A, arm 203 has been moved to the limit of its travel away from the viewer. In FIG. 3B, arm 203 has been moved to the limit of its travel toward the viewer. Arm 203 may also be centered on swivel 202, or may be positioned at an intermediate location. Preferably, an actuatable latch 301 enables the arm to be latched in a certain one of a number of preferred translational positions. Latch 301 is preferably actuatable without the use of tools.

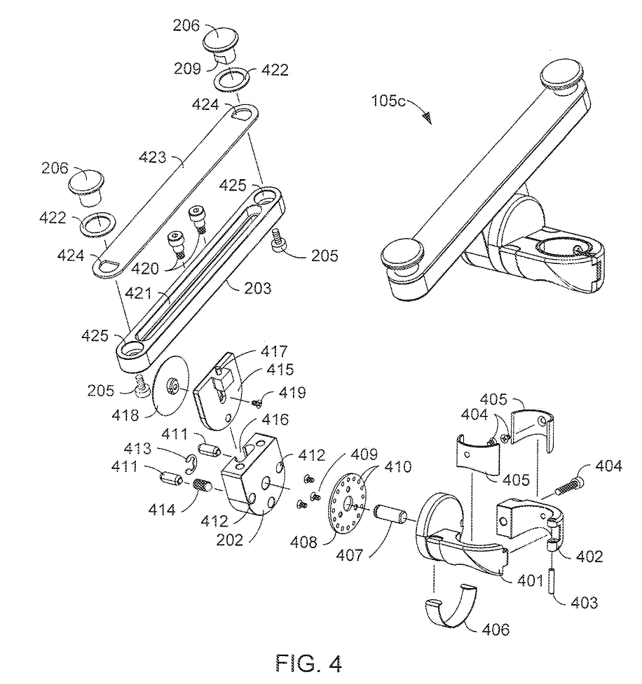

FIG. 4 shows assembled and exploded oblique views of a particular mounting assembly 105c, and shows details of the operation of the mounting assemblies, in accordance with embodiments of the invention. In the embodiment shown, clamp 201 is a swing clamp, and comprises a main portion 401 and a swing portion 402, which are rotatably coupled by a hinge pin 403. This arrangement enables the clamp swing open and to be coupled to one of the posts from the side of the post, rather than requiring that the clamp be passed over the end of the post, as has been necessary in some prior food shields. The swing claim arrangement of FIG. 4 thus allows, for example, a lower shelf to be added or removed without removing an upper shelf, and enables panels to be mounted and dismounted from posts that have bends without disassembling the posts. A screw or bolt 404 serves as a tightening mechanism for the clamp, enabling the clamp to be loosened or tightened on a post. Main portion 401 and swing portion 402 of the clamp are preferably made of metal, for example aluminum, stainless steel, brass, zinc, or another suitable metal, although non-metallic materials may be used in some applications. Portions 401 and 402 may be plated, polished, brushed, or otherwise treated for aesthetic appeal. Preferably, one or more bushings 405 are inserted into the clamp. Bushings 405 may be made of a material that substantially prevents marring of a post to which the clamp is coupled, for example acetal, nylon, polytetrafluoroethylene, or another suitable material. A clip spring 406 snaps over the clamp to cover the head of screw or bolt 404 once the clamp is tightened.

A pin 407 is affixed to main clamp portion 401, for example by a press fit or threading into a hole (not visible in FIG. 4) in main portion 401. Pin 407 serves as an axle to define an axis of rotation of parts of the clamp. The axis of rotation is transverse to a post on which the mounting assembly may be clamped. A detent disk 408 is also affixed to main clamp portion 401, for example by screws 409. A ring of holes 410 near the perimeter of detent disk 408 provide detents for the rotation of the arm of the mounting assembly, working in conjunction with two ball plungers 411. Detent disk 408 is preferably made of a hard, durable material such as steel. While detent disk 408 is shown having 16 detent holes, providing detent positions every 22.5 degrees in the rotation of swivel 202, one of skill in the art will recognize that more or fewer detent holes could be used, providing more or fewer angular detent positions.

Swivel 202 is journaled on pin 407, and rotates about the axis defined by pin 407. Swivel 202 is preferably made of materials similar to those of which clamp portions 401 and 402 are made, and carries the parts of the mounting assembly that are movable when the mounting assembly is clamped to a post. Swivel 202 may be captured on pin 407 by a C-ring 413 or a similar fastener. Ball plungers 411 may be threaded into or otherwise securely positioned in holes 412 in swivel 202 so that they engage holes 410 in detent disk 408, defining detent locations in the rotation of swivel 202 with respect to main clamp portion 401. So long as locking screw 414 is disengaged, swivel 202 can be moved without the use of tools between detent positions. Locking screw 414 may be tightened to engage with one of holes 410, locking swivel 202 in a certain angular position.

Latch 415 engages swivel 202 in a loose sliding fit, and is preferably upwardly biased by a spring, foam block, or the like (not visible in FIG. 4) placed within channel 416 in swivel 202. Here “upward” means the direction in relation to swivel 202 that appears upward in FIG. 4. In use, swivel 202 may be in a different orientation, and the biasing of latch 415 may actually be downward in relation to the overall food shield. Latch 415 includes a protrusion 417 configured to engage with any of a series of holes (not visible in FIG. 4) in arm 203. Protrusion 417 may be, for example, a steel dowel pin pressed into a hole in latch 415. When latch 415 is pushed downward, it disengages protrusion 417 from arm 203 and permits translational movement of arm 203. A cover 418 is loosely held to latch 415 by a screw 419 or other suitable fastener, such that cover 418 can slide with respect to latch 415. When cover 418 is in its nominal position, locking screw 414 is hidden. When cover 418 is pushed upward, it moves with respect to latch 415, exposing locking screw 414 so that locking screw 414 can be accessed to lock or unlock rotational motion of swivel 202.

Arm 203 is attached to swivel 202 using shoulder screws 420, which are recessed in groove 421 of arm 203. Shoulder screws 420 are sufficiently tall that arm 203 is free (but for its detent mechanism) to translate along its length. A panel such as panel 101a (not shown in FIG. 4) is affixed to arm 203 by means already described, using screws 205 and caps 206. Washers 422 may optionally be placed between caps 206 and the panel, for example to cushion the interface between caps 206 and the panel. Washers 422 may be made, for example, of vinyl or another suitable material.

Preferably, a plate cover 423 resides between the panel and arm 203. Plate cover 423 comprises two flat-sided holes 424, aligned with holes 425 near the ends of arm 203. The flat sides of flat-sided holes 424 engage the flattened portions 209 of caps 206, preventing rotation of caps 206 when screws or bolts 205 are tightened. Placing the flat-sided holes in plate cover 423 simplifies the manufacture of the mounting assembly, as plate cover 423 may be economically stamped, laser cut, or otherwise formed from a sheet material. Plate cover 423 and arm 422 are preferably made of materials similar to those of which clamp portions 401 and 402 and swivel 202 are made.

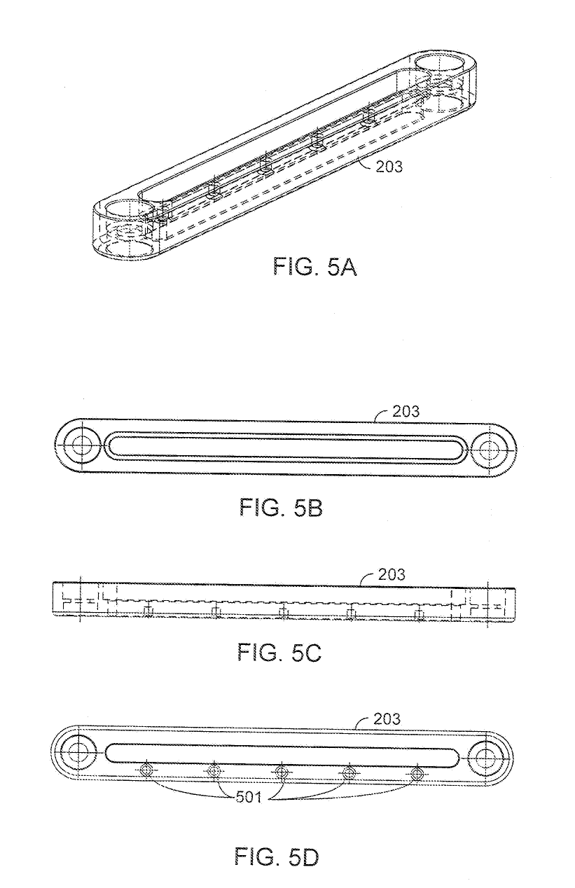

FIGS. 5A-5D show oblique, top, side, and bottom views respectively of example arm 203. These views illustrate a set of detent holes 501 in the bottom side (as oriented in FIG. 4) of arm 203. Protrusion 417 on latch 415 is configured to engage one of the detent holes at a time to hold the arm in a certain translational location. While five detent holes are shown on arm 203, one of skill in the art will recognize that other numbers of holes could be used, defining more or fewer detent locations. Arm 203 can thus be positioned in any of several translational detent locations. The direction of translation is transverse to the axis of rotation defined by pin 407.

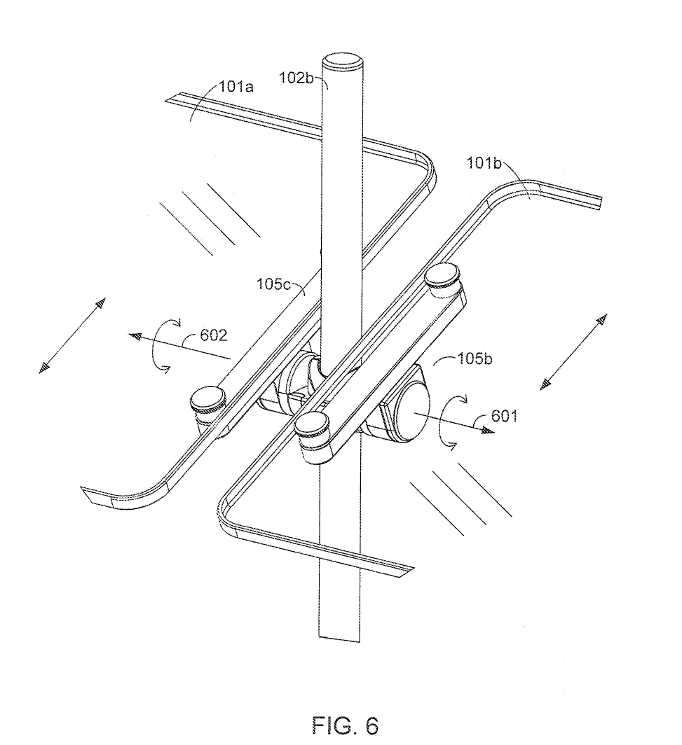

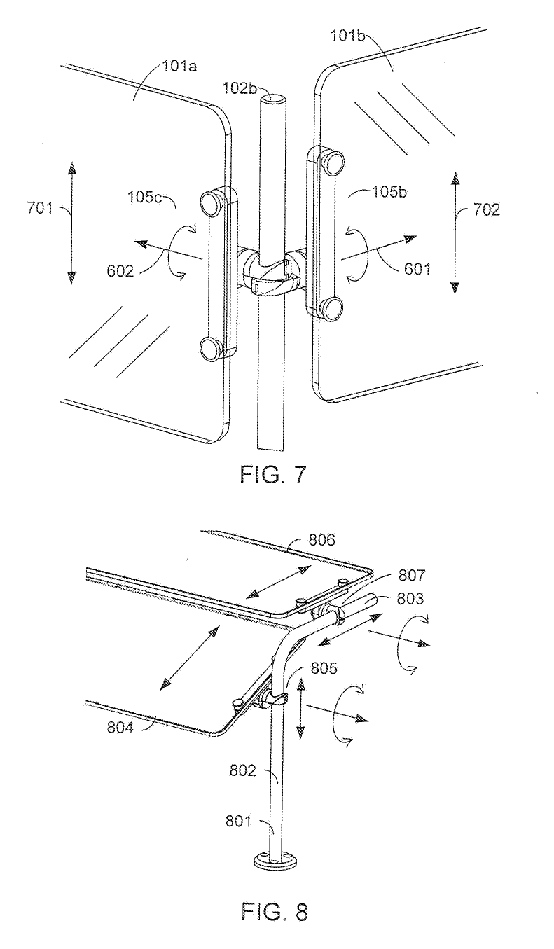

Mounting assembly according to embodiments of the invention enable a wide range of food shield configurations. For example, FIG. 6 shows a portion of food shield 100, enlarged to illustrate how two mounting assemblies can be clamped to the same post 102b, with their axes of rotation 601 and 602 aligned, in accordance with embodiments of the invention. The two mounting assemblies 105b and 105c are substantially identical, but one is inverted with respect to the other to align the axes of rotation. In the example of FIG. 6, the axes of rotation 601 and 602 are collinear, so that panels 101a and 101b can rotate about a common axis, and can be positioned to be co-planar if desired. In other embodiments, axes 601 and 602 could be positioned at the same height with respect to post 102b, but may intersect. An example of this arrangement is shown in FIG. 7, showing panels 101a and 101b positioned vertically (parallel with the longitudinal axis of post 102b) but at right angles to each other, to form a corner. Many other intermediate angles could be configured, both for relationship of axes 601 and 602, and for the angular positions of panels 101a and 101b. Of course, panels 101a and 101b may be positioned at any workable translational location as well, as indicated by arrows 701 and 702. In FIG. 7, panel 101b has been translated upward to illustrate the translational capability of mounting assembly 105b.

FIG. 8 illustrates another arrangement for a food shield, in accordance with embodiments of the invention. In this example, post 801 is formed with a right angle, so that post 801 has a vertical section 802 and a horizontal section 803. Panel 804 is coupled to vertical section 802 using a mounting assembly 805, and panel 806 is coupled to horizontal section 803 using mounting assembly 807. Panel 806 is positioned horizontally, to serve as a shelf. Each panel can be adjusted in position along its respective portion of post 801, and can also be adjusted in angular position or translational position, if desired. For example, panel 804 could be positioned in a horizontal orientation to serve as another shelf, or could be placed in a vertical orientation to serve as a divider. Because mounting assembly 805 uses a swing clamp arrangement, panel 804 may be easily removed from the system, without any need to cut or dismount post 801.

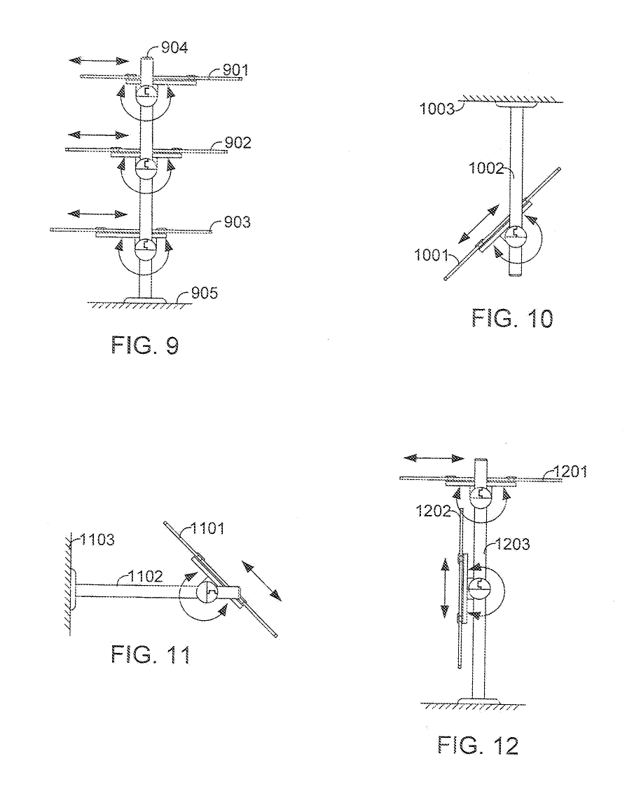

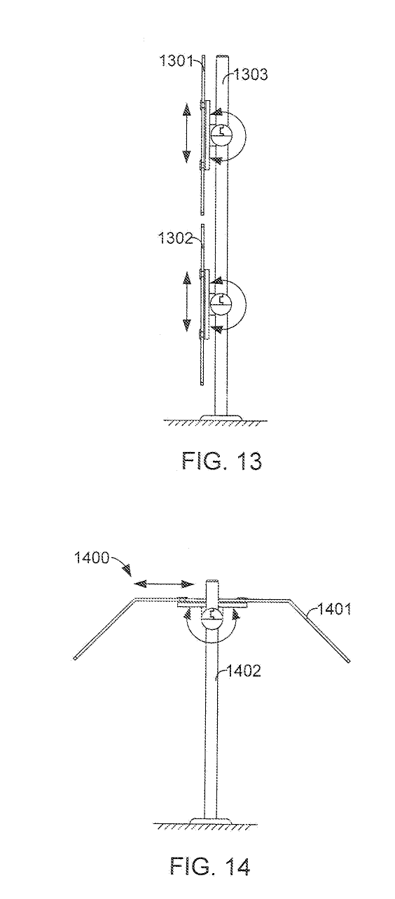

Many other arrangements are possible in accordance with embodiments of the invention, some of which are depicted schematically in FIGS. 9-14. For example, FIG. 9 shows an end view of an arrangement in which three shelves 901, 902, and 903 arc mounted to a vertical post 904, which is mounted to a base 905. The upper shelf 901 and lower shelf 903 have been translated in relation to post 904, illustrating some of the adaptability of the mounting assemblies. FIG. 10 shows an example arrangement in which a sneeze guard panel 1001 is mounted to a post 1002 that is in turn mounted to an overhead surface 1003. FIG. 11 illustrates a sneeze guard panel 1101 that is mounted to a horizontal post 1102 that is in turn mounted to a vertical surface 1103. FIG. 12 illustrates a food shield in which a first panel 1201 is positioned in an orientation transverse to post 1203, and a second panel 1202 is positioned in an orientation parallel to post 1203. FIG. 13 illustrates a food shield with two panels, 1301 and 1302, both positioned in an orientation parallel to post 1303.

While the panels illustrated thus far have been substantially planar, one of skill in the art will recognize that this is not a requirement. FIG. 14 illustrates a food shield 1400 having a non-planar panel 1401 mounted to post 1402 using a mounting assembly according to embodiments of the invention. In any of the illustrated embodiments, the panels are adjustable angularly about an axis transverse to the post, and can be translated in a direction transverse to the axis of rotation.

The invention has now been described in detail for the purposes of clarity and understanding. However, those skilled in the art will appreciate that certain changes and modifications may be practiced within the scope of the appended claims.

What is claimed is:

1. A food shield, comprising:
at least one post having a longitudinal axis defining a length;
a clamp coupled to the post, the clamp being loosenable to enable the clamp to be moved along the length of the post, and the clamp also being tightenable to fix the clamp at a certain location on the post;
a swivel coupled to the clamp, the swivel being rotatable with respect to the clamp about a rotational axis that is transverse to the longitudinal axis of the post;
an arm coupled to the swivel and extending from the swivel, the arm being translatable with respect to the swivel along a translational axis that is transverse to the rotational axis; and
a panel coupled to the arm such that the panel is movable to different angular positions by rotating the arm, and the panel is movable to different translational locations by translating the arm with respect to the swivel.

2. The food shield of claim 1, wherein the clamp further comprises a main portion and a swing portion that is rotatable away from the main portion to open the clamp, enabling the clamp to be coupled to the post from a side of the post.

3. The food shield of claim 2, wherein the clamp further comprises a tightening mechanism operable to tighten the main portion and the swing portion of the clamp to the post, to fix the clamp at a certain location on the post, the tightening mechanism also being loosenable to enable the clamp to be moved along the length of the post.

4. The food shield of claim 3, wherein the tightening mechanism comprises a screw or bolt passing through either the main portion or the swing portion and threaded into the other portion.

5. The food shield of claim 1, further comprising:
a detent mechanism coupled to the clamp and the swivel, the detent mechanism defining a set of angular detent positions for the panel; and
a locking mechanism that when engaged fixes the panel in a certain angular position.

6. The food shield of claim 5, wherein when the locking mechanism is disengaged, the panel can be moved angularly without the use of tools.

7. The food shield of claim 1, wherein the arm comprises two holes, one near each end of the arm, through which threaded fasteners pass to couple the panel to the arm, and wherein the food shield further comprises:
two caps, each cap having a shank and an enlarged head, wherein the panel resides between the heads and the arm and is drawn toward the arm by the threaded fasteners.

8. The food shield of claim 7, wherein each cap shank includes a flattened portion, and wherein the food shield further comprises a plate cover between the panel and the arm, the plate cover comprising two flat-sided holes, one aligned with each hole in the arm;
and wherein the flattened portions of the shanks engage the flat-sided holes to prevent rotation of the caps by the threaded fasteners.

9. The food shield of claim 1, further comprising a bushing in the clamp, the bushing made of a material that substantially prevents marring of the post by the clamp.

10. The food shield of claim 1, further comprising:
a set of detent holes in the arm; and
a latch coupled to the swivel, the latch comprising a protrusion configured to engage one of the detent holes at a time to hold the arm in a certain translational location;
wherein the latch is actuatable to disengage the protrusion to enable the arm to move to another translational position.

11. The food shield of claim 10, wherein the latch is actuatable without the use of tools.

12. The food shield of claim 1, wherein the post is substantially vertical.

13. The food shield of claim 1, wherein the post is substantially horizontal.

14. The food shield of claim 1, further comprising:
a second post displaced from the first;
a second clamp coupled to the second post;
a second swivel coupled to the second clamp; and
and a second arm coupled to the second swivel;
wherein the panel is also coupled to the second arm.

15. The food shield of claim 1, further comprising:
a second clamp coupled to the post;
a second swivel coupled to the second clamp;
a second arm coupled to the second swivel; and
a second panel coupled to the second arm.

16. A food shield, comprising:
at least one post having a longitudinal axis defining a length;
a clamp coupled to the post, the clamp comprising a main portion and a swing portion that is rotatable away from the main portion to open the clamp, enabling the clamp to be coupled to the post from a side of the post, and
a tightening mechanism operable to tighten the main portion and the swing portion of the clamp to the post, to fix the clamp at a certain location on the post, the tightening mechanism also being loosenable to enable the clamp to be moved along the length of the post;
an arm coupled to the clamp, the arm being rotatable with respect to the clamp about a rotational axis that is transverse to the longitudinal axis; and
a panel coupled to the arm such that the panel is movable to different angular positions by rotating the arm.

17. A food shield, comprising:
at least one post having a longitudinal axis defining a length;
a clamp coupled to the post, the clamp being loosenable to enable the clamp to be moved along the length of the post, and the clamp also being tightenable to fix the clamp at a certain location on the post;
a swivel coupled to the clamp, the swivel being rotatable with respect to the clamp about a rotational axis that is transverse to the longitudinal axis of the post;
an arm coupled to the swivel and extending from the swivel;
a panel coupled to the arm such that the panel is movable to different angular positions by rotating the arm, and the panel is movable to different translational locations by translating the arm with respect to the swivel;
a detent mechanism coupled to the clamp and the swivel, the detent mechanism defining a set of angular detent positions for the panel; and
a locking mechanism that when engaged fixes the panel in a certain angular position.

18. The food shield of claim 17, wherein when the locking mechanism is disengaged, the panel can be moved angularly without the use of tools.

19. A food shield, comprising:
a post having a longitudinal axis defining a length;
a first clamp and a second clamp coupled to the post, each clamp comprising a tightening mechanism operable to tighten the clamp to the post to fix the clamp at a certain location on the post, the tightening mechanism also being loosenable to enable the clamp to be moved along the length of the post;
a first arm coupled to the first clamp, the first arm being rotatable with respect to the first clamp about a first rotational axis that is transverse to the longitudinal axis;
a second arm coupled to the second clamp, the second arm being rotatable with respect to the second clamp about a second rotational axis that is transverse to the longitudinal axis; and
first and second panels coupled respectively to the first and second arms such that each panel is independently movable to different angular positions by rotating its respective arm;
wherein the first and second clamps are substantially identical, one clamp inverted with respect to the other to align the first and second rotational axes.

20. The food shield of claim 19, wherein the two rotational axes are coplanar and intersecting.

21. The food shield of claim 19, wherein the two rotational axes are collinear.

22. A method of protecting displayed food items, the method comprising:
providing a food shield comprising at least one post having a longitudinal axis defining a length; a clamp coupled to the post, the clamp being loosenable to enable the clamp to be moved along the length of the post, and the clamp also being tightenable to fix the clamp at a certain location on the post; a swivel coupled to the clamp, the swivel being rotatable with respect to the clamp about a rotational axis that is transverse to the longitudinal axis of the post; an arm coupled to the swivel and extending from the swivel, the arm being translatable with respect to the swivel along a translational axis that is transverse to the rotational axis; and a panel coupled to the arm such that the panel is movable to different angular positions by rotating the arm, and the panel is movable to different translational locations by translating the arm with respect to the swivel; and
rotating and translating the arm to position the panel in a combination of a certain angular position and a certain translational location such that the panel is between the displayed food items and a viewing location.

23. The method of claim 22, further comprising:
engaging a locking mechanism to hold the panel in the certain angular position.

24. A panel mounting assembly for mounting a panel in a food shield, the mounting assembly comprising:
clamp comprising a main portion and a swing portion that is rotatable away from the main portion to open the clamp, enabling the clamp to be coupled to the post from a side of a post, the clamp also comprising a tightening mechanism for tightening the clamp to the post to fix the clamp at a certain longitudinal position on the post;
a swivel rotatably coupled to the clamp main portion and configured to rotate about an axis that is transverse to a longitudinal axis of the post;
an arm coupled to the swivel, the arm configured to translate along an axis that is transverse to the axis of rotation, the arm comprising features for coupling a panel to the arm.

25. The panel mounting assembly of claim 24, further comprising a detent mechanism coupled to the clamp and the swivel, the detent mechanism defining a set of angular detent positions for the swivel; and
a locking mechanism that when engaged fixes the swivel in a certain angular position in relation to the clamp main portion.

26. The panel mounting assembly of claim 25, wherein when the locking mechanism is disengaged, the swivel can be rotated about the axis of rotation without the use of tools.

27. The panel mounting assembly of claim 25, wherein the locking mechanism is a screw, and wherein the panel mounting assembly further comprises a moveable cover for covering the screw.

28. The panel mounting assembly of claim 25, wherein the detent mechanism comprises:
a detent disk fixed to the clamp main portion, the detent disk having a set of holes near its perimeter; and
at least one ball plunger fixed to the swivel and engaging the detent disk such that when a ball of the ball plunger encounters one of the holes, a detent position is defined.

29. The panel mounting assembly of claim 24, further comprising:
a set of detent holes in the arm; and
a latch coupled to the swivel, the latch comprising a protrusion configured to engage one of the detent holes at a time to hold the arm in a certain translational location;
wherein the latch is actuatable to disengage the protrusion to enable the arm to move to another translational position.

30. The panel mounting assembly of claim 24, wherein the arm comprises two holes near its ends, and wherein the mounting assembly further comprises a plate cover having two flat-sided holes therethrough, each flat-sided hole aligned with one of the holes in the arm.

31. The panel mounting assembly of claim 24, further comprising at least one bushing in the clamp, the bushing made of a material that substantially prevents marring of the post by the clamp.

32. The panel mounting assembly of claim 24, wherein the tightening mechanism comprises a screw or bolt, and wherein the panel mounting assembly further comprises a clip that removably clips to the clamp to hide a head of the screw or bolt.
